(19) United States
(12) Patent Application Publication
(10) Pub. No.: US 2018/0027430 A1
(43) Pub. Date: Jan. 25, 2018

(54) TECHNIQUES FOR LOCATING DISTRIBUTED ANTENNA LOCATIONS

(71) Applicant: Zinwave Limited, Cambridge (GB)

(72) Inventors: Matthew P. Pasulka, Huntsville, AL (US); Andrew Robert Bell, Cambridge (GB)

(21) Appl. No.: 15/215,460

(22) Filed: Jul. 20, 2016

(51) Int. Cl. H04W 24/04; H04B 7/04; H04W 64/00

(52) U.S. Cl. CPC H04W 24/04; H04W 64/003; H04B 7/04; H04W 84/12

(57) ABSTRACT

Embodiments of the present invention provide techniques for locating network components in a distributed antenna system. A DAS can include various antennas located within a deployment environment. The DAS may include a centralized hub that may interface with various broadband sources and manage access to the broadband sources for devices that connect to the DAS. In some embodiments, the centralized hub may communicate with one or more remote units that convert signals received from the centralized hub to be communicated using one of the distributed antennas. Components of the DAS may be associated with a beacon. The beacon can be configured to determine that the signal has been lost (e.g., due to component failure) and can begin transmitting an identification signal (e.g., a “ping”). The identification signal transmitted by the beacon may then be used to identify the location of the faulty component for servicing.

### BACKGROUND

Wireless networking is an increasingly common feature provided by businesses, residential and commercial spaces, municipalities, and other areas. Wireless networks enable many common devices, such as desktop computers, laptop computers, smartphones, digital cameras, tablet computers and digital audio players, to communicate with one another, access network resources, connect to other networks, such as the internet, etc. A wireless network may be deployed using one or more access points arranged in a deployment environment (including indoor and outdoor locations).

These networks are increasingly installed in user-dense environments, such as dense commercial and residential buildings, event spaces, and the like. This leads to more client devices connecting to these networks, which requires additional equipment and infrastructure to support these networks. The cost and space required to retrofit a building with sufficient equipment can be significant. This has led to the planning and installation of network systems during construction, which allows for equipment to be located out of the way (e.g., within walls or other underutilized spaces). However, while this saves space and simplifies deployment, the equipment may also be difficult to locate for servicing.

Embodiments of the present invention provide techniques that address these and other problems in network environments.

### SUMMARY

Embodiments of the present invention provide techniques for locating network components in a distributed antenna system (DAS). A DAS can include various antennas located within a deployment environment. The DAS may include a centralized hub that may interface with various broadband sources and manage access to the broadband sources for devices that connect to the DAS. In some embodiments, the centralized hub may communicate with one or more remote units that convert signals received from the centralized hub to be communicated using one of the distributed antennas. For example, where the centralized hub communicates with a remote unit over a fiber optic connection, the remote unit may transduce the signal from an optical signal to an electrical signal before driving the signal over the antenna. In some embodiments, each remote unit may be associated with a beacon. The beacon can be configured to determine that the signal has been lost (e.g., due to component failure) and can begin transmitting an identification signal (e.g., a “ping”). In some embodiments, the beacon can use a dedicated antenna incorporated into the beacon or can use the same antenna to which the beacon is deployed. The signal transmitted by the beacon may then be used to identify the location of the faulty component for servicing. When the faulty hardware has been fixed, or the signal otherwise restored, the beacon can detect a reset condition and cease transmitting.

### BRIEF DESCRIPTION OF THE DRAWINGS

Various embodiments in accordance with the present disclosure will be described with reference to the drawings, in which:

FIG. 1 illustrates an example of a distributed antenna system, in accordance with embodiments of the present invention;

FIGS. 2A and 2B illustrate alternative beacon configurations, in accordance with an embodiment of the present invention;

FIG. 3 illustrates a block diagram of a beacon, in accordance with an embodiment of the present invention;

FIG. 4 illustrates a method of using a beacon to locate network components in a distributed antenna system, in accordance with an embodiment of the present invention;

FIG. 5 illustrates a high level block diagram of a computer system, in accordance with an embodiment of the present invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present invention are directed to a distributed antenna system (DAS) that includes a beacon system for locating components of the DAS. As noted above, network systems are increasing installed to buildings during construction, enabling network components to be installed behind walls and panels. This saves space within the livable areas of the buildings, but also may make the components difficult to find. For example, plans may change during construction, resulting in some components being installed in different locations from those indicated on the plans. Similarly, different components than expected may be installed in some locations due to human error and changes during construction. For example, if it is determined that Component A is malfunctioning, the building plans may be used to determine the location of Component A. However, during installation Component B may have been installed by mistake, making the location of Component A potentially more difficult to identify without disassembling various locations in the building.

Embodiments of the present invention provide techniques for locating network components in a distributed antenna system. A DAS can include various antennas located within a deployment environment. The DAS may include a centralized hub that may interface with various broadband sources and manage access to the broadband sources for devices that connect to the DAS. In some embodiments, the centralized hub may communicate with one or more remote units that convert signals received from the centralized hub to be communicated using one of the distributed antennas. For example, where the centralized hub communicates with a remote unit over a fiber optic connection, the remote unit may transduce the signal from an optical signal to an electrical signal before driving the signal over the antenna. In some embodiments, each remote unit may be associated with a beacon. The beacon can be configured to determine that the signal has been lost (e.g., due to component failure) and can begin transmitting an identification signal (e.g., a “ping”). In some embodiments, the beacon can use a dedicated antenna incorporated into the beacon or can use the same antenna to which the beacon is deployed. The signal transmitted by the beacon may then be used to identify the location of the faulty component for servicing. When the faulty hardware has been fixed, or the signal otherwise restored, the beacon can detect a reset condition and cease transmitting.

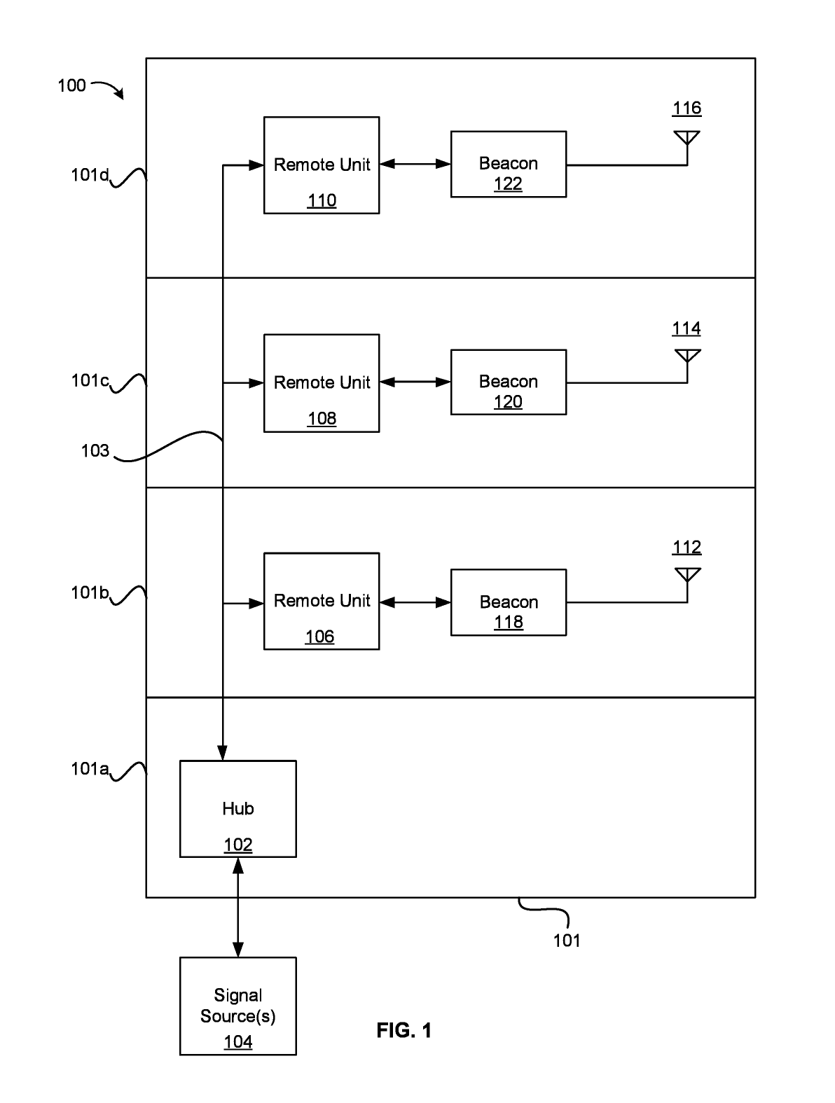

FIG. 1 illustrates an example of a distributed antenna system 100, in accordance with embodiments of the present invention. As shown in FIG. 1, a distributed antenna system (DAS) 100 can be installed in a deployment environment 101, such as a residential, commercial, or office building. The distributed antenna system may be deployed across a number of zones, such as floors 101a-101d, of the deployment environment. Although four zones are shown in FIG. 1 arranged as floors in a residential or office building, more or fewer zones may also be present in a deployment environment, which may be arranged in various configurations depending on the deployment environment.

As shown in FIG. 1, in some embodiments DAS 100 can include a hub 102. Hub 102 can be configured to receive signals from one or more signal sources 104, such as mobile phone base stations, wired or wireless Internet or LANs, or other signals. Hub 102 can transmit data from the one or more signal sources 104 to each zone using remote units 106, 108, 110. In some embodiments, hub 102 can be connected to each remote unit 106, 108, 110 through fiber optic cables. Alternatively, coaxial or other transmission line may be used to connect hub 102 to remote units 106, 108, 110. In some embodiments, hub 102 can be configured to receive signals from one or more client devices that connect to DAS 100 through antennas 112, 114, 116. Each antenna may include active elements electrically connected to the transmission line, and passive elements such as stubs. Although single lines are shown connecting the components of DAS 100, in various embodiments separate transmit and receive lines may be maintained depending on deployment.

In various embodiments, DAS 100 may provide service to multiple client devices. The client devices may include personal computers, cell phones, handheld messaging devices, laptop computers, set-top boxes, personal data assistants, and any other suitable devices configured to send and receive information over a network. Although embodiments of the present invention are described herein with respect to a wireless local area network (WLAN) implemented using devices that support the IEEE 802.11 family of specifications, the DAS can support any appropriate signal source, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail.

In the example shown in FIG. 1, deployment environment 101 is a building, having a first floor 101a and three additional floors 101b, 101c, 101d. Hub 102 can be installed in the first floor 101a (e.g., a basement, lobby, or other floor where space may be less of a premium). One or more fiber optic lines 103 can connect hub 102 to remote units 106, 108, 110 deployed to floors 101b, 101c, 101d, respectively. In some embodiments, fiber optic lines 103 can include multimode fiber optic lines configured to carry optical signals modulated onto carrier signals, enabling multiple services to be provided without additional down-conversion. In various embodiments, a connector bank may be used to connect fiber optic lines 103 to hub 102, enabling connections to be added or removed as needed for a given deployment. For example, in FIG. 1, hub 102 may have three hub connectors that connect hub 102 to a connector bank which connect to three fiber optic lines running to floors 101b, 101c, and 101d. In some embodiments, fiber optic lines 103 may be run along a vertical riser to each floor. At each floor the line may be connected to one or more telecommunications outlets where one or more additional DAS components may be connected to the fiber optic line 103. In various embodiments, DAS components may be connected to the fiber optic lines using pluggable connectors, splices, or other connections or combinations of connections.

Although one antenna is shown deployed to each floor, this is for simplicity of depiction and explanation. The number and location of antennas deployed to a given zone (e.g., floor) will vary depending on the deployment environment (e.g., indoor/outdoor placement, height, local physical obstructions, etc.), anticipated usage, antenna type, power output, and local interference (e.g., from other devices operating in the same frequency range).

In some embodiments, hub 102 is connected to receive input signals from, and to provide output signals to one or more signal sources 104. Signal source 104 can include an access point that provides access to various network resources, such as a wired LAN, one or more local or remote servers, data stores, and other resources. Digital signals sent by the access point can be converted to optical signals to be transmitted on fiber optic lines 103 to the remote units. For example, in some embodiments, remote unit 106, 108, 110 may include an electro-optical transducer module, which may include a photodiode to convert downlink optical signals received from hub 102 over fiber optic lines 103 into electrical signals to be transmitted using antennas 112, 114, 116. The transducer module may also include a laser to convert uplink electrical signals received from antennas 112, 114, 116 into optical signals to be sent to hub 102 over fiber optic lines 103.

Remote unit 106, 108, 110 may further include additional electronics modules configured to modulate/demodulate the electrical and optical signals as needed as well as to drive the transducer module. In some embodiments, digital to optical conversion can include modulating a carrier signal with the digital signals received from the access point before transducing the modulating signal using a photoelectric transducer. Each remote unit 106, 108, 110 can receive the modulated signal over fiber optic lines 103. The remote units may include a photoelectric transducer to convert the modulated signal from the received optical signal to a modulated digital signal. The remote units can demodulate the signal as needed from the carrier signal used for optical propagation and can be modulated using a carrier signal for wireless transmission. The access point signal may then be transmitted on each floor using antennas 112, 114, 116.

As discussed above, DAS 100 may be deployed during construction of the deployment environment. For example, remote units 106, 108, 110 and antennas 112, 114, 116 may be installed at various locations on floors 101b, 101c, 101d as those floors are finished (e.g., within walls, above ceilings, etc.). The locations for each component may be specified in deployment plans which may be used to locate the components later in cases of failure, for service, for regular maintenance, etc. Because the locations of components may change during deployment, without updates being made to the deployment plan, it may become difficult to locate some components in the future.

Embodiments of the present invention use one or more beacons 118, 120, 122 associated with components of the DAS. Each beacon can monitor its associated component to determine whether the component is operating within specified parameters. For example, the beacon can stay dormant until it is determined that that the associated component is no longer operating within the specified parameters. In various embodiments, beacons can be associated with different components. For example, one or more beacons may be configured to monitor an antenna and/or a remote unit. In some embodiments, different beacons may be used to monitor the functioning of a component in the uplink direction and the downlink direction.

In some embodiments, once activated, a beacon can provide wireless notification, visual notification, and/or acoustic notification. For example, if beacon 118 is monitoring remote unit 106, and determines that remote unit 106 is not functioning according to specified parameters, a transmitter in beacon 118 can be activated and, using antenna 112, a wireless notification signal can be broadcast. The wireless notification signal can include a repeating ping or other periodic signal. In some embodiments, the beacon may act as an access point or ad hoc node. In this example, the wireless notification signal can include wireless LAN (e.g., IEEE 802.11 standards compatible) network signal, enabling a locator device to connect to the beacon and locate the beacon based on network signal strength. In some embodiments, depending on deployment location, the beacon may be configured to provide a visual notification. For example, the beacon may be connected to a light source (e.g., a light fixture in a livable area of the deployment environment) which the beacon may cause to blink in a specified pattern and/or which the beacon may cause to deactivate. In some embodiments, a light on the beacon itself may be activated which may be identified in, e.g., a drop ceiling, crawlspace, or other access area. Additionally, or alternatively, the beacon may be configured to emit an acoustic notification. The acoustic notification may be an audible, infrasonic, ultrasonic, or other sonic notification. One or more acoustic monitors may be used to triangulate the location of the beacon.

In some embodiments, where a failure affects multiple components, causing multiple beacons to activate (e.g., a connection failure in a transmission line that drives multiple components), the activated beacons may be used to identify an approximate location of the failure. For example, a portion of a line between a functioning component and a nonfunctioning component can be identified based on the beacon location of the nonfunctioning component, and that portion may be analyzed to determine a cause of the failure and/or replaced.

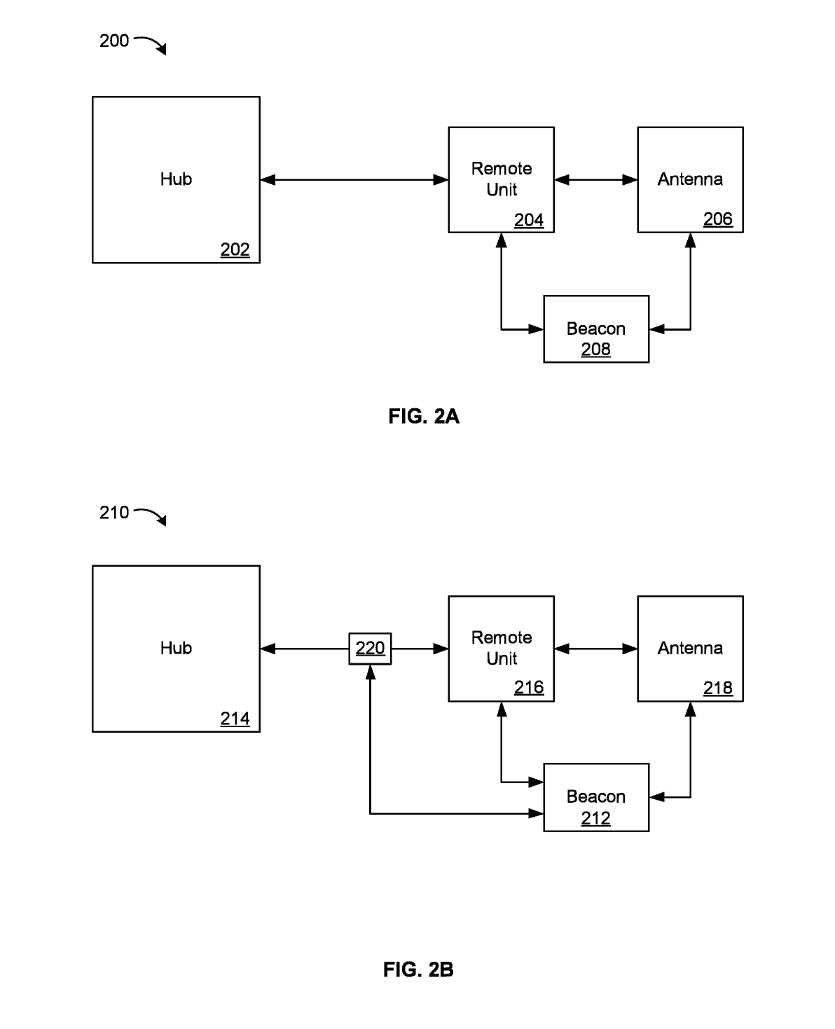

In the embodiment shown in FIG. 1, beacons 118, 120, 122 is deployed in series between remote units 106, 108, 110 and antennas 112, 114, 116. Each beacon therefore can monitor for faults from either the remote units or the antennas and a notification may be triggered due to a fault from either component (e.g., due to a lack of a received signal from either component). As discussed below with respect to FIGS. 2A and 2B, additional beacon configurations may also be used in various embodiments.

FIGS. 2A and 2B illustrate alternative beacon configurations, in accordance with an embodiment of the present invention. As shown in FIG. 2A, a first beacon configuration 200 can include hub 202 connected to remote unit 204. As discussed above, a hub may communicate with a remote unit over a fiber optic, coaxial, or any other transmission line. Additionally, although a single line is shown in the examples of FIGS. 2A and 2B, multiple transmission lines may connect the hub to a remote unit. Remote unit 204 may then connect directly to antenna 206. By contrast to the example of FIG. 1, beacon 208 is connected to the remote unit and antenna in parallel. By connecting beacon 208 in parallel, a potential source of interference and potential additional failure point is removed from the transmission path. Additionally, although beacon 208 is shown connected to both remote unit 204 and antenna 206, in some embodiments each component may be connected to a different beacon.

Beacon 208 can receive a signal from each connected component, which in the example of FIG. 2A includes remote unit 204 and antenna 206. In some embodiments, the signal may include a heartbeat signal indicating that the component is still functioning. In some embodiments, the signal may include all or a portion of signal received or transmitted by the connected component from which the functionality of the component can be determined by the beacon. For example, remote unit 204 and/or antenna 206 may include a splitter on the uplink and/or downlink connection to send all or a portion of the signal to the beacon 208. Beacon 208 may analyze the signal using known digital signal processing techniques to determine signal characteristics. The signal characteristics can be compared to predefined failure conditions which may be defined for the component being monitored. For example, a signal to noise ratio threshold or a signal amplitude threshold may be used to determine whether a signal is present.

FIG. 2B illustrates a second beacon configuration 210, in accordance with an embodiment of the present invention. In the example of FIG. 2B, beacon 212 can receive signals from hub 214, remote unit 216, and antenna 218. In some embodiments, beacon 212 can receive all or a portion of the signal received by remote unit 216 from hub 214 through a splitter or other branch component at node 220. The beacon 212 can compare the signal received from hub 214 through node 220 to a signal received from remote unit 216. By comparing the signals the beacon can determine whether the remote unit 216 has failed or whether the failure occurred between the hub 214 and the remote unit 216. In some embodiments, when the beacon 212 detects a failure condition the notification signal transmitted by the beacon may vary depending on which component is associated with the failure condition. For example, if a signal is detected from the hub, but not from the remote unit, the beacon can determine the remote unit has failed. Beacon 212 may then transmit a notification signal that identifies the remote unit as being the source of failure. However, if no signal is received from the hub, the beacon may determine that there is a failure with a component, but not necessarily the remote unit. Beacon 212 may then transmit a notification signal indicating that the beacon has detected a failure but that the failure is likely not at the location of the beacon. As discussed above, such a failure likely affects multiple components and associated beacons. The notification signals from the affected beacons may then be used to determine a likely location of the failure between hub 214 and remote unit 216.

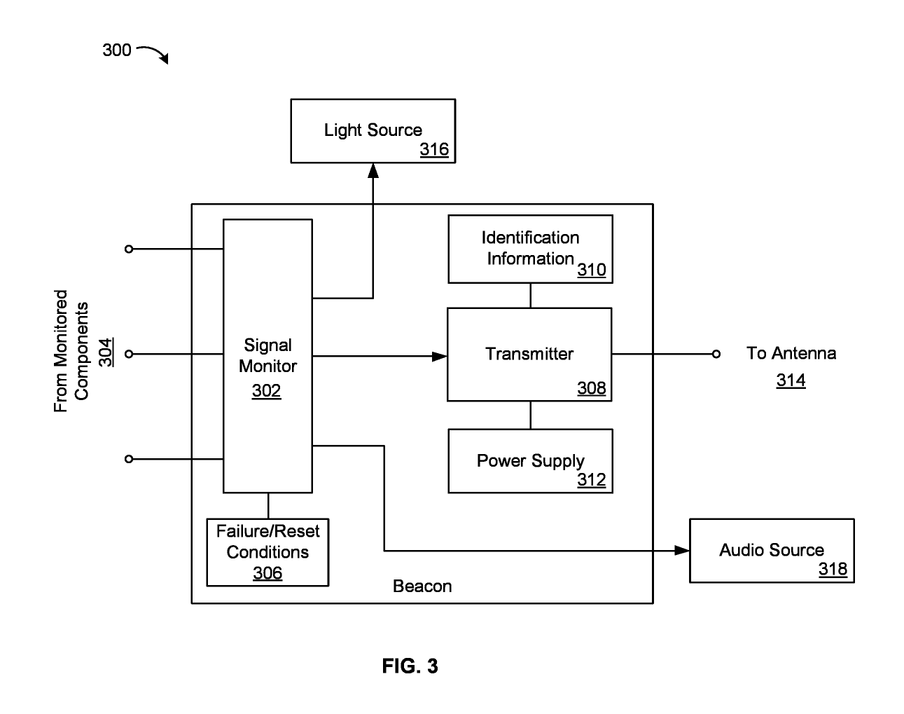

FIG. 3 illustrates a block diagram of a beacon 300, in accordance with an embodiment of the present invention. As discussed above, beacon 300 may be used to monitor one or more components of a DAS, such as DAS 100 of FIG. 1 and to broadcast one or more notification signals in the event of component failure. As shown in FIG. 3, a beacon 300 can include a signal monitor 302. Signal monitor 302 may be configured to receive signals from one or more monitored components 304. In the example shown in FIG. 3, signal monitor 302 is configured to receive three signals from one or more monitored components. In various embodiments signal monitor may be configured to receive more or fewer signals depending on implementation and number of components being monitored.

Signal monitor 302 can receive signals from one or more monitored components 304. As discussed above, the signals may include one or more heartbeat signals, all or a portion of the data signal being processed by the monitored components, or any other signal that indicates, or can be used to determine, whether the monitored component is operating within specified parameters. For example, a monitored component may be configured to transmit a heartbeat signal at a regular interval to beacon 300. Signal monitor 302 can receive the heartbeat signal and record any missed heartbeats. The record of missed heartbeats can be compared to failure conditions 306 which may define failure conditions for each monitored component. For example, failure conditions 306 may indicate that a sequence of five consecutive missed heartbeats indicates failure of the monitored component. Additionally, or alternatively, failure conditions 306 may also indicate that a missed heartbeat rate of 30% in a predetermined period of time indicates failure of the monitored component, regardless of whether the missed heartbeats are consecutive.

Additionally, or alternatively, signal monitor 302 can receive all or a portion of the data signal being processed by a monitored component. In some embodiments, beacon 302 may be signal agnostic. For example, as long as a signal is detected, the beacon may determine that the monitored component is functioning within specified parameters, without needing to analyze the content of the signal. As such, signal monitor 302 can analyze a received signal and determine one or more signal characteristics, such as signal to noise ratio (SNR), average power, average amplitude, pulse amplitude, or other analog or digital signal characteristics. A failure condition may be defined as a threshold for at least one signal characteristic. For example, a failure condition may define a minimum average voltage of a received signal over a specified period of time. As a signal is received from the monitored component by signal monitor 302, an average voltage of the received signal can be determined. If the average voltage of the signal drops below the minimum threshold for the specified period of time, the beacon 302 may activate one or more notification signals.

In some embodiments, signal monitor 302 may receive a continuous signal indicating, e.g., that the monitored component is receiving power and/or turned on. For example, an emergency power supply, a device cooling system, a safety system, or any other component that does not directly process a data signal but supports one or more other components which process a data signal. This enables components which may require service to be located before component failure directly impacts service. Additionally, this enables components that are used infrequently (such as an emergency or backup power supply), but which enable continuous service in the event of unplanned events (such as power loss), to be serviced when the components fail but before they need to be relied upon.

In some embodiments, components may be configured to send a signal to beacon 300 only in the event of failure and/or to request service. For example, component 304 may include an inverter which causes a signal to be sent to beacon 300 when a signal at the component goes to zero. A failure condition may be defined for these components as the presence of a signal at beacon 300 over a specified period of time (e.g., to prevent the beacon from activating due to a short period of inactivity).

In various embodiments, beacon 300 may receive signals from monitored components through wired or wireless connections. In some embodiments, e.g., where a DAS is serving as a distributed access point, a beacon may be associated with each distributed antenna and may connect to the wireless network through its associated antenna. The connection to the wireless network may therefore act as the signal monitored by the signal monitor 302. If connection to the wireless network is lost, the outage may be recorded and compared to the failure conditions 306 associated with the DAS. For example, if the outage is continuous and lasts longer than a specified time then the antenna and/or remote unit monitored by the beacon may be determined to have failed and the beacon may activate. Similarly, if connection is lost for a specified portion of time (e.g., greater than 10% in a given period) then the antenna and/or remote unit monitored by the beacon may be determined to have failed and the beacon may activate.

In some embodiments, the particular conditions that indicate failure may vary from component to component. As noted above, the type of signal received from a component may vary depending on the type of component being monitored. As such, the failure conditions defined for that monitored component may similarly vary. Failure conditions may be defined by an administrator and/or a manufacturer associated with each component. In some embodiments, failure conditions may be modified by connecting to a beacon and uploading updated failure conditions. For example, if a beacon is being activated frequently and it is determined that the monitored component is working normally, the failure condition for that component may be determined to have a threshold that is set too low (or too high). By adjusting the threshold, the sensitivity of the beacon to that failure condition can be reduced, resulting in fewer false positives.

In some embodiments, when a failure condition is identified, signal monitor 302 can activate a notification signal. A failure condition may be associated with a notification type (e.g., wireless, visible, acoustic,) to be activated. For example, a failure condition may be associated with a wireless notification. When signal monitor 302 determines that the failure condition has been met, signal monitor 302 can activate transmitter 308. Transmitter 308 may retrieve identification information 310 (e.g., a beacon identifier, a failed component identifier, or other identification information) and generate a notification signal. For example, a carrier signal may be modulated with the identification information 310 and transmitted using antenna 314. In some embodiments, beacon 302 may include a dedicated power supply 312 to power the beacon and transmitter in case of generalized or local power loss.

In some embodiments, when a failure condition is identified, signal monitor 302 can activate light source 316 and/or audio source 318 to transmit notification signals. Light source 316 and/or audio source 318 may be activated in addition, or as an alternative, to activation of transmitter 308 based on the type or types of notification signals associated with the failure condition. In some embodiments, the beacon may be connected to a light source 316 (e.g., a light fixture in a livable area of the deployment environment) which the beacon may cause to blink in a specified pattern and/or which the beacon may cause to deactivate. In some embodiments, a light on the beacon itself may be activated which may be identified in, e.g., a drop ceiling, crawlspace, or other access area. In some embodiments, the light source may be an infrared light source which creates an area that is locally warmer than the surrounding area such that the location can be identified using an infrared camera or other image capture device. Ultraviolet light sources and light sources specific to other spectra may also be used. In some embodiments, an acoustic notification may be transmitted using audio source 318. The acoustic notification may be an audible, infrasonic, ultrasonic, or other acoustic notification. One or more acoustic monitors (e.g., microphones or other acoustically sensitive devices) may be used to triangulate the location of the acoustic notification signal.

Although the example of FIG. 3 shows antenna 314, light source 316, and audio 318 as being external components to beacon 300, this is for simplicity of depiction and description. In various embodiments, any or all of antenna 314, light source 316, and audio 318 may be incorporated into beacon 300 such that beacon 300 is a self-contained unit with all components in a shared housing.

In some embodiments, signal monitor 302 can continue to monitor signals from the monitored components 304 after a failure condition has been detected. Signal monitor 302 can continue monitoring to determine whether a reset condition 306 has been detected. In some embodiments, a reset condition may be the absence of a failure condition. For example, once the malfunctioning component has been repaired or replaced, signal monitor 302 may monitor the signal from the repaired or replaced component and in the absence of a detected failure condition the beacon may be deactivated. In some embodiments, when a malfunction component is repaired or replaced, the repaired or replaced component may send a reset signal to beacon 300. In some embodiments, the reset signal may be an identifier associated with the component, with the beacon, with the DAS deployment or any other identifier. In some embodiments, the reset signal may be a handshake that establishes communication between the beacon and the component using one or more known handshake protocols. Once reset the beacon may deactivate the transmitter 308, light source 316, and/or audio source 318 as appropriate. In some embodiments, beacon 300 may include a physical reset switch or other mechanism which may be operated by a technician to reset the beacon after it has been located, deactivating the transmitter 308, light source 316, and/or audio source 318.

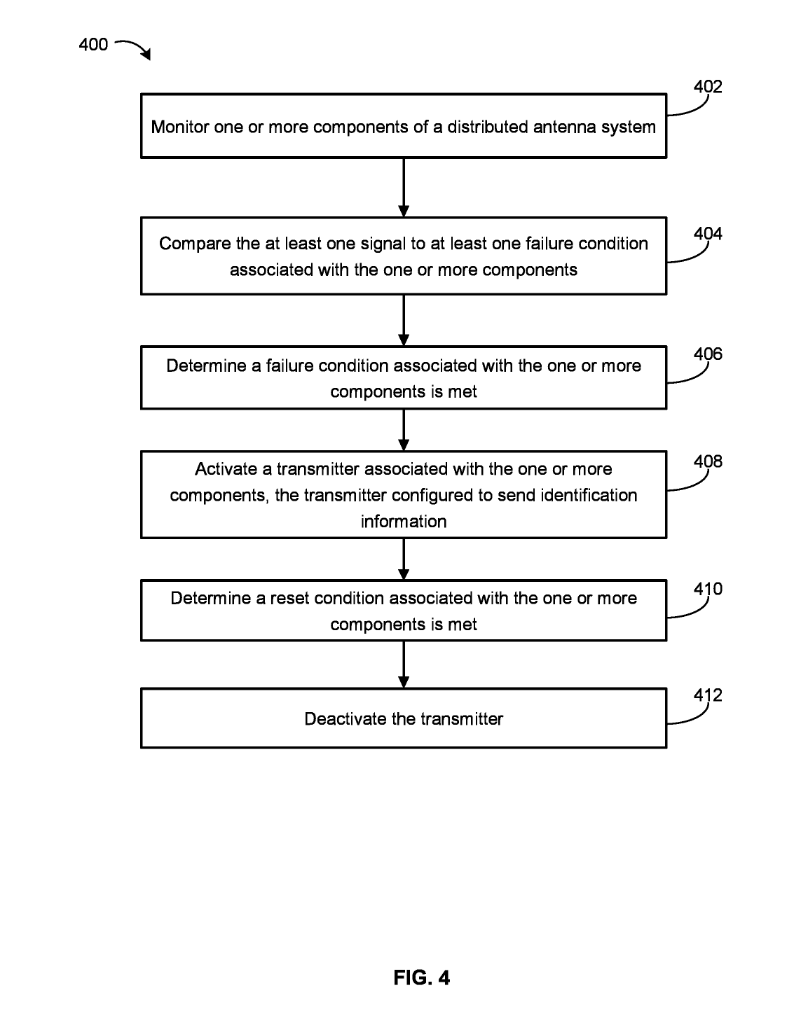

FIG. 4 illustrates a method 400 of using a beacon to locate an antenna in a distributed antenna system, in accordance with an embodiment of the present invention. At 402, at least one signal received from one or more components of a distributed antenna system can be monitored. As discussed above, a beacon can be associated with one or more components of a DAS including, e.g., a remote unit, an antenna, and any other component. The beacon can receive multiple signals from the DAS and the monitored components, such as a signal from a hub, a remote unit, an antenna, etc. The signals can include all or a portion of the data signal being transmitted by the DAS, a heartbeat signal from the monitored component, or other signals.

At 404, the at least one signal can be compared to at least one failure condition associated with the one or more components. Failure conditions may be defined for the particular component or type of component being monitored and/or based on the signal that is being received from the monitored component. The failure conditions may include threshold data defined for particular signal characteristics, such as average power, average amplitude, signal to noise ratio, or other signal characteristics. The threshold data may also include a temporal component, such as a specified amount of time during which the signal characteristic must be less than or greater than the threshold. The amount of time may be defined as a continuous amount of time or as a percentage of time in a longer period. In some embodiments, a failure condition may specify a discrete number of events (e.g., a number of consecutive missed heartbeats) that indicate that the monitored component has failed. In some embodiments, where a signal is sent only when a component has failed, the failure condition may be defined as the presence of the signal for a specified period of time.

At 406, it can be determined that the at least one failure condition has been met. As discussed above, the at least one signal received from the one or more components may be analyzed to determine a signal characteristic and this signal characteristic can be compared to the threshold data defined in the at least one failure condition. For example, it may be determined that the average power of the at least one signal has been below a threshold value for more than a specified amount of time. As another example, it may be determined that the monitored component has failed to send ten consecutive heartbeats.

At 408, a transmitter associated with the one or more components can be activated, the transmitter configured to send a notification signal. The notification signal may be associated with a notification type, such as a wireless notification, a visual notification, or an acoustic notification. When it is determined that a failure condition has been met, a notification of the type or types associated with the failure condition can be sent. For example, a wireless notification may include activating a wireless local area network signal. This can enable a locator device to connect to the beacon and determine the location of the beacon based on the signal strength. Similarly, in some embodiments, the wireless notification signal may be a periodic signal, or ping, that includes an identifier associated with the beacon or with the one or more components. In some embodiments, the wireless notification signal may be transmitted using an antenna from the DAS. In other embodiments, the wireless notification signal may be transmitted using a dedicated antenna incorporated into the beacon.

At 410, at least one reset condition associated with the one or more components can be determined to have been met. In some embodiments, the reset condition may be the absence of the failure condition. In some embodiments, the reset condition may be receipt of a reset signal from a repaired or replaced component. The reset signal may be a handshake signal to enable communication between the repaired or replaced component and the beacon. In some embodiments, the reset condition may be the manual activation of a reset switch or other mechanism on the beacon. At 412, the transmitter can be deactivated.

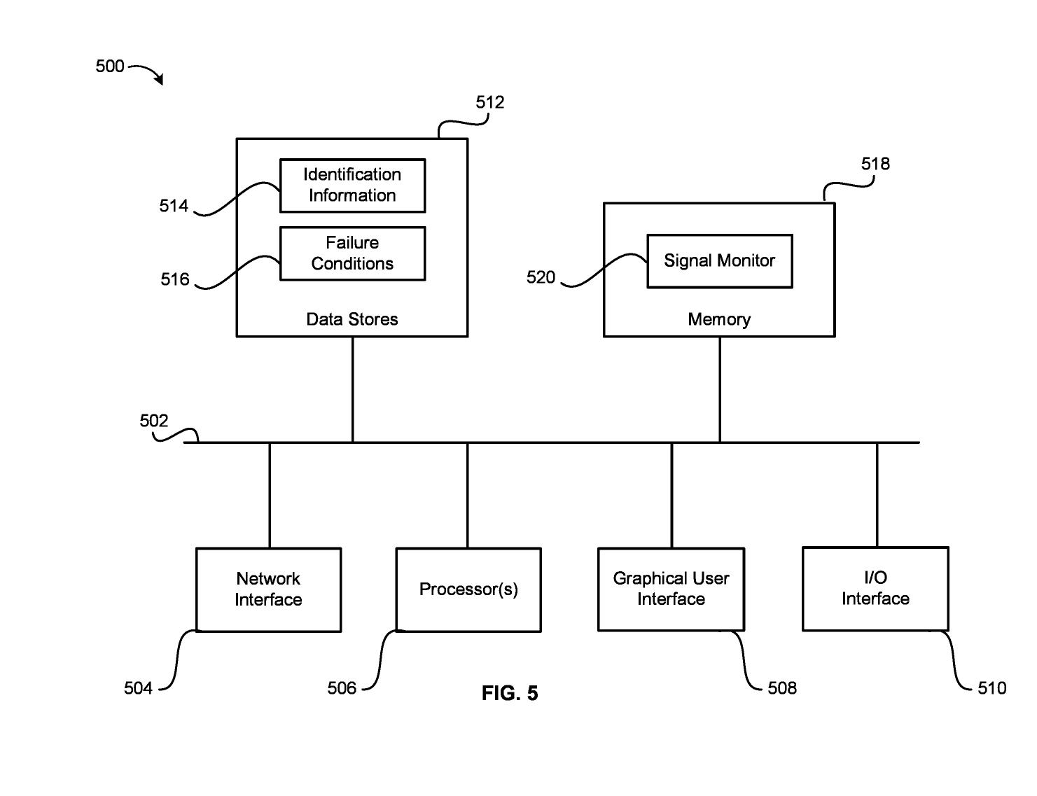

FIG. 5 illustrates a high level block diagram of a computer system 500, in accordance with an embodiment of the present invention. As shown in FIG. 5, a computer system can include hardware elements connected via a bus 502, including a network interface 504, that enables the computer system to connect to other computer systems over a wireless local area network (WLAN), wide area network (WAN), mobile network (e.g., EDGE, 3G, 4G, or other mobile network), or other network. Network interface 504 can further include a wired or wireless interface for connecting to infrared, Bluetooth, or other wireless devices, such as other client devices, network resources, or other wireless capable devices. The computer system can further include one or more processors 506, such as a central processing unit (CPU), field programmable gate array (FPGA), application-specific integrated circuit (ASIC), network processor, or other processor. Processers may include single or multi-core processors.

In some embodiments, the computer system can include a graphical user interface (GUI) 508. GUI 508 can connect to a display (LED, LCD, tablet, touch screen, or other display) to output user viewable data. In some embodiments, GUI 508 can be configured to receive instructions (e.g., through a touch screen or other interactive interface). In some embodiments, I/O interface 510 can include various interfaces for user input devices including keyboards, mice, or other user input devices.

In some embodiments, the computer system may include local or remote data stores 512. Data stores 512 can include various computer readable storage media, storage systems, and storage services, as are known in the art (e.g., disk drives, CD-ROM, digital versatile disk (DVD) or other optical storage, magnetic cassettes, magnetic tape, magnetic disk storage or other magnetic storage devices, relational databases, object storage systems, local or cloud-based storage services, or any other storage medium, system, or service). Data stores 510 can include data generated, stored, or otherwise utilized as described herein. For example, data stores 510 can include all or portions of identification information 514 as well as failure conditions 516, and other data. Memory 518 can include various memory technologies, including RAM, ROM, EEPROM, flash memory or other memory technology. Memory 518 can include executable code to implement methods as described herein, such as signal monitor 520.

A computing device typically will include an operating system that provides executable program instructions for the general administration and operation of that computing device and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
monitoring at least one signal received from one or more components of a distributed antenna system;
comparing the at least one signal to at least one failure condition associated with the one or more components;
determining the at least one failure condition has been met;
activating a transmitter associated with the one or more components, the transmitter configured to send a notification signal;
determining at least one reset condition associated with the one or more components has been met; and
deactivating the transmitter.

2. The method of claim 1, the failure condition is associated with a notification type, wherein the notification type includes at least one of a wireless notification, a visual notification, and an acoustic notification.

3. The method of claim 2, wherein the wireless notification includes a wireless local area network signal.

4. The method of claim 2, wherein the wireless notification includes an identifier associated with the one or more components and wherein the wireless notification is transmitted periodically.

5. The method of claim 4, wherein the wireless notification is transmitted by the transmitter using an antenna from the distributed antenna system.

6. The method of claim 1, wherein the at least one failure condition specifies threshold data including one or more signal characteristic thresholds indicating failure of the one or more components.

7. The method of claim 6, wherein comparing the at least one signal to at least one failure condition associated with the one or more components further comprises:
analyzing the at least one signal to determine at least one signal characteristic; and
comparing the at least one signal characteristic to the threshold data.

8. A distributed antenna system comprising:
a plurality of beacons, wherein each beacon is associated with one or more components of the distributed antenna system, wherein each beacon configured to:
monitor at least one signal received from the one or more components of the distributed antenna system;
compare the at least one signal to at least one failure condition associated with the one or more components;
determine the at least one failure condition has been met;
activate a transmitter associated with the one or more components, the transmitter configured to send a notification signal;
determine at least one reset condition associated with the one or more components has been met; and
deactivate the transmitter.

9. The distributed antenna system of claim 8, the failure condition is associated with a notification type, wherein the notification type includes at least one of a wireless notification, a visual notification, and an acoustic notification.

10. The distributed antenna system of claim 9, wherein the wireless notification includes a wireless local area network signal.

11. The distributed antenna system of claim 9, wherein the wireless notification includes an identifier associated with the one or more components and wherein the wireless notification is transmitted periodically.

12. The distributed antenna system of claim 11, wherein the wireless notification is transmitted by the transmitter using an antenna from the distributed antenna system.

13. The distributed antenna system of claim 1, wherein the at least one failure condition specifies threshold data including one or more signal characteristic thresholds indicating failure of the one or more components.

14. The distributed antenna system of claim 13, wherein comparing the at least one signal to at least one failure condition associated with the one or more components further comprises:
analyzing the at least one signal to determine at least one signal characteristic; and
comparing the at least one signal characteristic to the threshold data.

15. A non-transitory computer readable storage medium including instructions stored thereon which, when executed by a processor, cause the processor to:
monitor at least one signal received from one or more components of a distributed antenna system;
compare the at least one signal to at least one failure condition associated with the one or more components;
determine the at least one failure condition has been met;
activate a transmitter associated with the one or more components, the transmitter configured to send a notification signal;
determine at least one reset condition associated with the one or more components has been met; and
deactivate the transmitter.

16. The non-transitory computer readable storage medium of claim 15, the failure condition is associated with a notification type, wherein the notification type includes at least one of a wireless notification, a visual notification, and an acoustic notification.

17. The non-transitory computer readable storage medium of claim 16, wherein the wireless notification includes a wireless local area network signal.

18. The non-transitory computer readable storage medium of claim 16, wherein the wireless notification includes an identifier associated with the one or more components and wherein the wireless notification is transmitted periodically, wherein the wireless notification is transmitted by the transmitter using an antenna from the distributed antenna system.

19. The non-transitory computer readable storage medium of claim 15, wherein the at least one failure condition specifies threshold data including one or more signal characteristic thresholds indicating failure of the one or more components.

20. The non-transitory computer readable storage medium of claim 19, wherein comparing the at least one signal to at least one failure condition associated with the one or more components further comprises:
analyzing the at least one signal to determine at least one signal characteristic; and
comparing the at least one signal characteristic to the threshold data.
